(19) United States
(12) Patent Application Publication
(10) Pub. No.: US 2026/0003975 A1
(43) Pub. Date: Jan. 1, 2026

(54) ARRANGEMENT AND METHOD OF PRIVILEGE ESCALATION DETECTION IN A HOST

(71) Applicant: WithSecure Corporation, Helsinki (FI)

(72) Inventor: Jarno NIEMELÄ, Helsinki (FI)

(21) Appl. No.: 19/247,045

(22) Filed: Jun. 24, 2025

(30) Foreign Application Priority Data
Jun. 26, 2024 (GB) 2409132.4

(51) Int. Cl. G06F 21/57

(52) U.S. Cl. CPC G06F 21/577; G06F 2221/034

(57) ABSTRACT

A method of privilege escalation risk detection in a host, such as a computer, and/or a network, such as a computer network, is disclosed. The method comprises: examining which executables are running in the host, searching, e.g. from a behavioral data source, behavioral information of the executables running in the host, performing a first identification phase for identifying executables running in the host which the behavioral information indicates are known to be run with an elevated privilege, performing a second identification phase by checking file access permissions to the executables identified in the first identification phase for identifying executables which are writable and/or modifiable by a privilege level lower than the elevated privilege, e.g. a privilege level other than administrator or system level privileges, and generating an alert for the executables identified in the second identification phase.

### CROSS-REFERENCE TO RELATED APPLICATION

This application claims the benefit of and priority to United Kingdom (GB) Patent Application No. 2409132.4 filed Jun. 26, 2024, the contents of which being incorporated by reference in their entirety herein.

### TECHNICAL FIELD

The present disclosure relates to an arrangement and a method of privilege escalation detection in a host.

### BACKGROUND

Malware detection and scanning is a vital issue for the security of any kind of endpoints and networks. Malware detection and scanning is generally directed to identify and potentially also disinfect any kind of malware on computer and/or communication systems, such as viruses, Trojans, worms, or other kinds of security threats.

Privilege escalations in computer and computer networks are a problematic category of vulnerabilities to find, as they often are caused by incorrect permissions configuration in a particular host, which means that what is a vulnerable in one host may not be the case in another. Therefore, privilege escalation may not always be found just by doing code analysis or analyzing a freshly installed version of an application or a system.

Typically, the privilege escalation may be detected only when it has already happened. To lower the risk and give organizations more time to react to threat it would be important to detect a possible privilege escalation before attack happens. Therefore, it would be desirable to enable a reliable privilege escalation detection which is able to detect risk of privilege escalation before the privilege escalation is used.

One known method used by threat actors (e.g. attackers) to gain User Account Control (UAC) bypass is modifying a file that the user is frequently running with elevated privileges. On a host (e.g. developer computers) one specific example of this kind of file may be SysInternals Process Explorer tool, which is commonly used by Windows developers and other advanced users. The problem is that this tool is downloaded as a ZIP file from Microsoft, and installed where-ever the user wants to install it. This means that the location of this tool varies depending on the host or user, i.e. the location of this tool is specific to a given host or user. There may also exist other similar example files used by threat actors, where the exact what file is beneficial for the threat actors to modify can be specific to a given host or user. For the threat actors this is not a problem, since the threat actors can observe running files and see which of them the user is running with the elevated privileges. But for a defender spotting and preventing host specific vulnerabilities is difficult.

### BRIEF SUMMARY

The following presents a simplified summary in order to provide basic understanding of some aspects of various disclosure embodiments. The summary is not an extensive overview of the disclosure. It is neither intended to identify key or critical elements of the disclosure nor to delineate the scope of the disclosure. The following summary merely presents some concepts of the disclosure in a simplified form as a prelude to a more detailed description of example embodiments of the disclosure.

An objective of the disclosure is to present a method, an arrangement, a computer program, and a computer-readable medium for privilege escalation risk detection in a host. Another objective of the disclosure is that the method, the arrangement, the computer program, and the computer-readable medium for privilege escalation risk detection in a host enable detecting a possible privilege escalation risk even before an attack happens, which in turn lowers the risk and gives organizations more time to react to threats.

The objectives of the disclosure are reached by a method, an arrangement, a system, a computer program, and a non-transitory, computer-readable medium as defined by the respective independent claims.

According to a first aspect, the disclosure relates to a method, e.g., a computer implemented method, of privilege escalation risk detection in a host, such as a computer, and/or a network, such as a computer network, wherein the method comprises: examining which executables are running in the host; searching, e.g. from a behavioral data source, behavioral information of the executables running in the host; performing a first identification phase for identifying executables running in the host which the behavioral information indicates are known to be run with an elevated privilege; performing a second identification phase by checking file access permissions to the executables identified in the first identification phase for identifying executables which are writable and/or modifiable by a privilege level lower than the elevated privilege, e.g. a privilege level other than administrator or system level privileges; and generating an alert for the executables identified in the second identification phase.

The behavioral data source may comprise at least one of the following: process execution telemetry, process EDR source, process MDR source, a process monitor, such as a Sysinternals Process Monitor.

The alert may be sent to an exposure management service and/or to a vulnerability management service.

The detected privilege escalation risk may be used for determining at least one of the following: a risk score for the host, a risk score for an attack path on which the host is, a risk score for the organization relating to the host.

The method may further comprise gathering in the first identification phase at least one of the following: every executable executed by an elevated privileged executable, every dynamic link library loaded by an elevated privileged executable and every registry key value read and executed by an elevated privileged executable.

The behavioral information for an executable may comprise at least one of the following: process execution information, read and/or write access rights relating to the executable, e.g. write access to the location from which the executable is reading.

The method may be performed by the host, such as the computer.

Alternatively or in addition, the method may be performed by a virtual machine or software emulator running on a server.

The second identification phase may further comprise checking file access permissions to the executables identified in the first identification phase for identifying executable which are writable and/or modifiable by a privilege level lower than the elevated privilege and known to be executed by the executables identified in the first identification phase.

The method may further comprise determining whether a required directory structure is creatable to a computer file system in the host and an executable could be executed with an elevated privilege from that directory structure if the executable location does not exist on the computer file system in the host.

According to a second aspect, the disclosure relates to a system or an arrangement for privilege escalation risk detection in a host, such a computer, and/or a network, such a computer network, wherein the arrangement comprises at least one computer, wherein the computer is configured: to examine which executables are running in a host; to search, e.g. from a behavioral data source, behavioral information of the executables running in the host; to perform a first identification phase for identifying executables running in the host which the behavioral information indicates are known to be run with an elevated privilege; to performing a second identification phase by checking file access permissions to the executables identified in the first identification phase for identifying executables which are writable and/or modifiable by a privilege level lower than the elevated privilege, e.g. a privilege level other than administrator or system level privileges; and to generate an alert for the executables identified in the second identification phase.

The arrangement may be configured to carry out a method as described above.

According to a third aspect, the disclosure relates to a computer program comprising instructions which, when executed by a computer, cause the computer to carry out a method according to the disclosure.

According to a fourth aspect, the disclosure relates to a non-transitory computer-readable medium comprising the computer program according to the disclosure.

With the solution of the disclosure, it's possible to lower the risk and give organizations more time to react to threats by detecting a possible privilege escalation even before an attack happens. At least some aspects of the disclosure, improve spotting and preventing host specific vulnerabilities.

Various exemplifying and non-limiting embodiments of the disclosure both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

The embodiments of the disclosure are illustrated by way of example, and not by way of limitation, in the figures of the accompanying drawings.

FIG. 1 presents as a schematic diagram a system for which example embodiments of the present disclosure are applicable.

FIG. 2 presents schematically an example module composition of the solution according to one embodiment of the disclosure.

FIG. 3 presents an example of a method for privilege escalation risk detection is a host as a signaling diagram.

FIG. 4 presents another example of the method for privilege escalation risk detection in the host.

FIG. 5 presents as a schematic diagram an example of a structure of an arrangement according to example embodiments of the present disclosure.

### DETAILED DESCRIPTION

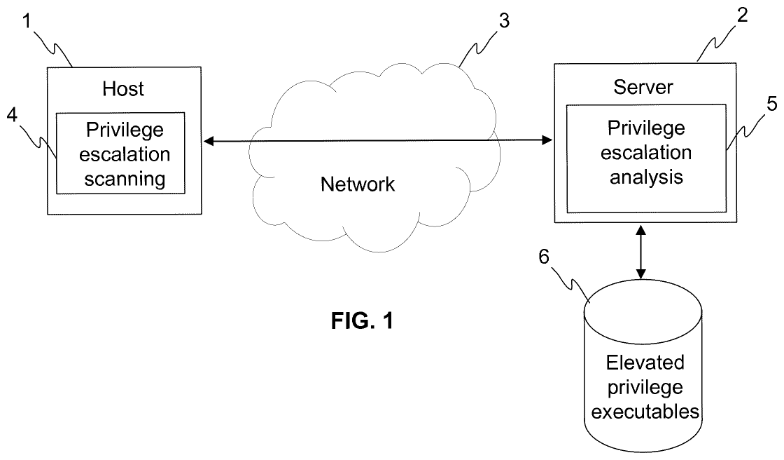

FIG. 1 illustrates an example of a system where the present disclosure may be applied. In the solution of FIG. 1 a system configuration is presented in which a host 1 and a remote entity or server 2 are connected via a network 3. Here, the host 1 exemplifies any computer or communication system, including a single device, a network node or a combination of devices, e.g. a network, such as a computer network, on which privilege escalation risk detection is to be performed.

The privilege escalation risk detection can be done at the host 1 and/or at the server 2. For example, the host 1 may include a personal computer, a personal communication device, a network-enabled device, a client, a firewall, a mail server, a proxy server, a database server, or the like. The server 2 exemplifies any computer or communication system, including a single device, a network node or a combination of devices, e.g. a network, such as a computer network, on which malware scanning can be performed for the host 1, or which can provide data for the host 1 required to carry out the privilege escalation risk detection at the host 1. For example, the server 2 may include a security entity or a backend entity of a security provider, or the like, and the server 2 may be realized in a cloud implementation or the like.

The network 3 exemplifies any computer or communication network, including, e.g., a (wired or wireless) local area network like LAN, WLAN, Ethernet, or the like, a (wired or wireless) wide area network like WiMAX, GSM, UMTS, LTE, or the like, and so on. Hence, the host 1 and the server 2 can but do not need to be located at different locations. For example, the network 3 may be any kind of TCP/IP-based network. Insofar, communication between the host 1 and the server 2 over the network 3 can be realized using for example any standard or proprietary protocol carried over TCP/IP, and in such protocol a privilege escalation risk scanning agent 4 at the host 1 and the privilege escalation risk analysis sandbox or application 5 at the server 2 can be represented on/as the application layer.

The system may further comprise an elevated privilege executable database 6 in which data of executables which are executed with elevated privilege, e.g. privilege above a certain level, have been stored. These kinds of executables are also called as elevated privilege executables in this disclosure. The elevated privileges are privileges that grant additional permissions beyond (i.e. higher than) normal privileges (e.g. standard/normal user level privileges). In other words, the elevated privileges grant the ability to do more than can be done with the user level privileges. Data to the elevated privilege executable database 6 may have been collected previously based on behavioral data of elevated privileged applications from a suitable source, for example from a behavioral data source. The behavioral data source may for example comprise at least one of the following: a process execution telemetry, a process endpoint detection and response (EDR) source, a process managed detection and response (MDR) source, a process monitor, such as a Sysinternals Process Monitor.

It should be noted that collection of data to the elevated privilege executable database 6 need not be stopped before the privilege escalation scanning is performed but may also continue during the scanning and after that to keep the data up to date.

The elevated executable database 6 may for example be located in a server and/or in a so-called “cloud” and/or in the host 1.

In the following, an example of a method for privilege escalation risk detection in the host 1 will be described with reference to the flow diagram of FIG. 3 and the system of FIG. 1. In this example the privilege escalation risk detection is performed by the server 2. The privilege escalation risk scanning agent 4 is started at the host 1 and the privilege escalation risk analysis application 5 is started at the server 2, if they are not already running.

The privilege escalation risk analysis application 5 in the server 2 may send 301 a message (e.g. a first message) to the privilege escalation risk scanning agent 4 in the host 1 to scan 302 the host 1 for every executable in the host 1. In other words, the privilege escalation risk scanning agent 4 starts to examine 302 which executables are running in the host 1. During the scanning the privilege escalation risk scanning agent 4 searches, e.g. from the behavioral data source, behavioral information of the executables running in the host 1. The behavioral information for an executable may for example comprise at least one of the following: process execution information, read and/or write access rights relating to the executable, e.g. write access to the location from which the executable is reading.

When the data has been collected the data is transmitted 303 to the server 2, the privilege escalation risk analyzing agent 5 performs 304 a first identification phase for identifying executables running in the host 1 which the behavioral information indicates are known to be run with an elevated privilege. For example, if the system comprises the elevated privilege executable database 6, the privilege escalation risk analyzing agent 5 may compare found executables with information of the elevated privilege executable database 6 to determine whether that executable belongs to the elevated privilege executables. If the first identification phase reveals that the executable is known to be run with the elevated privilege, that executable may for example be included, by the privilege escalation risk analyzing agent 5, in a first list.

According to example embodiments of the disclosure, the privilege escalation risk analysis application 5 in the server 2 may send 305 a message (e.g. a second message) to the privilege escalation risk scanning agent 4 in the host 1 to further gather 306, e.g. from the behavioral data source, at least one of the following: every executable (e.g. executable file) executed by an elevated privileged executable, every dynamic link library loaded by an elevated privileged executable and every registry key value read and executed by an elevated privileged executable. In other words, the first identification phase may further comprise that the privilege escalation risk scanning agent 4 further gathers executable executed by each elevated executable identified in the first identification phase, dynamic link library loaded by each elevated executable identified in the first identification phase, and/or registry key values read and executed by each elevated executable identified in the first identification phase. The gathered data may be then transmitted 307 to the server 2. The gathered data may further be included in the first list.

After the first identification phase, the privilege escalation risk analyzing agent 5 performs 308 a second identification phase by checking file access permissions to the executables identified in the first identification phase for identifying executables which are writable and/or modifiable by a privilege level lower than the elevated privilege. In other words, in the second identification phase the privilege escalation risk analyzing agent 5 identifies from among the executables identified in the first identification phase executables which are writable and/or modifiable by a privilege level lower than the elevated privilege by checking file access permissions to the executables identified in the first identification phase. If the second identification phase reveals that the executable is writable and/or modifiable by the privilege level lower than the elevated privilege, that executable may for example be included in a second list.

The privilege level lower than the elevated privilege may for example be any privilege level other than administrator or system level privileges or any other similar level privileges, e.g. root level privileges. For example, the privilege level lower than the elevated privilege may be a user level privilege, e.g. a user level permission. Executables which are writable and/or modifiable by a privilege level lower that the elevated privilege are also called as lower-level privilege executables in this disclosure.

If any executables are identified in the second identification phase, the privilege escalation risk analyzing agent 5 generates 309 an alert for the executables identified in the second identification phase. For example, if the executables identified in the second identification phase are included in the second list, the privilege escalation risk analyzing agent 5 may generate the alert for the executables which have been included in the second list. The alert may for example be sent to an exposure management service and/or to a vulnerability management service to provide an indication of potential privilege escalation risk(s). The alert may be, for example, a flag (e.g., one bit) which is set to a value “true” (e.g., by setting the value of the bit to 1) indicative of a detected potential privilege escalation risk. The alert may alternatively or in addition be sent to the host 1 to indicate potential privilege escalation risk(s). The privilege escalation risk analyzing agent 5 may for example generate a report or other information of the executables identified in the second identification phase and send it to the target host 1.

If the host 1 receives indication of potential privilege escalation risk(s), the host 1 may display that information and/or may prevent such low-level privilege executable being modifiable or may even prevent the executable running or stop the executable if it is already running.

It should be noted that the above-mentioned preventive measures are just examples of possible actions to avoid privilege escalation happening in the host 1.

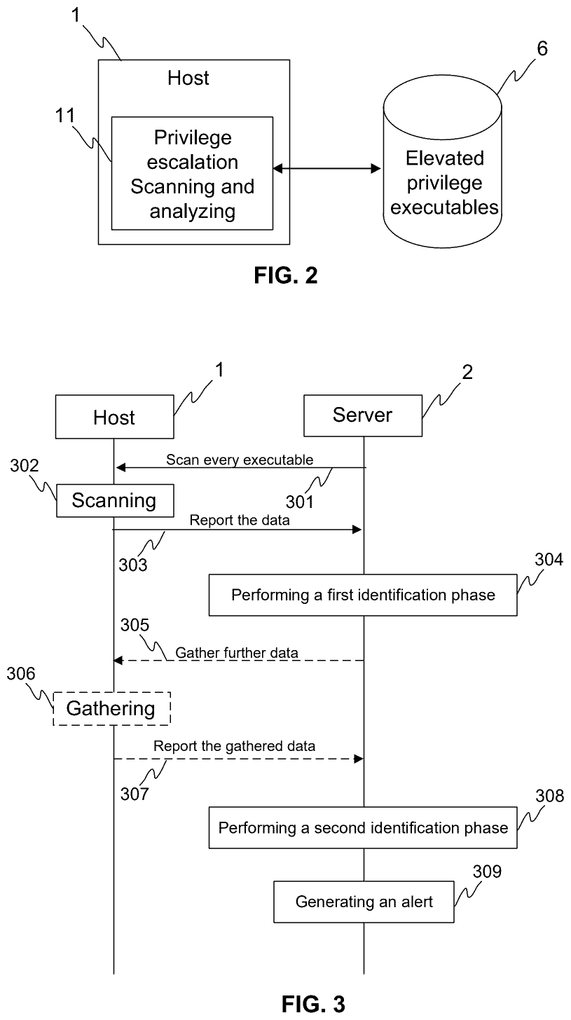

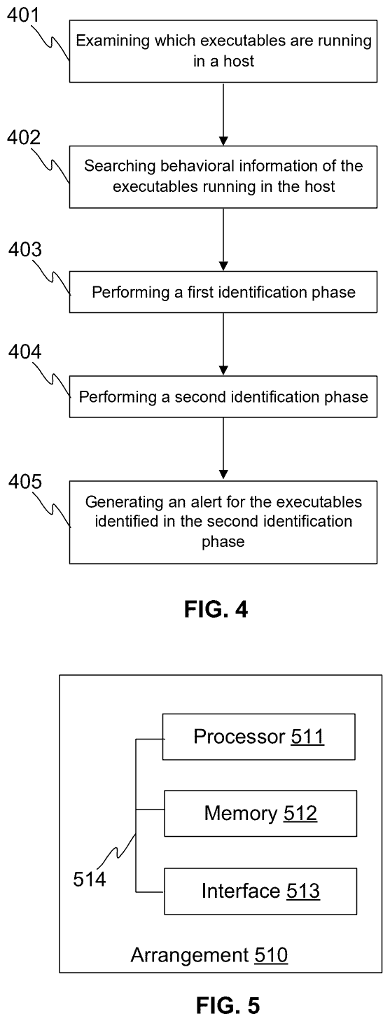

FIG. 2 illustrates another example of the privilege escalation risk detection. In the following, another example of the method for privilege escalation risk detection in the host 1 will be described with reference to the flow diagram of FIG. 4 and the system of FIG. 2. In this example the privilege escalation scanning is performed by the host 1. In other words, in this example the method is performed by the host 1.

The privilege escalation risk scanning and analyzing agent 11 is started at the host 1, if it is not already running. The privilege escalation risk scanning and analyzing agent 11 starts to scan 401 the host 1 for every executable in the host 1. In other words, the privilege escalation risk scanning and analyzing agent 11 starts to examine 401 which executables are running in the host 1. During the scanning the privilege escalation risk scanning and analyzing agent 11 searches 402, e.g. from the behavioral data source, behavioral information of the executables running in the host 1. The behavioral information for an executable may for example comprise at least one of the following: process execution information, read and/or write access rights relating to the executable, e.g. write access to the location from which the executable is reading.

After performing the search at the step 402, the privilege escalation risk scanning and analyzing agent 11 performs 403 a first identification phase for identifying executables running in the host 1 which the behavioral information indicates are known to be run with an elevated privilege. For example, if the system comprises the elevated privilege executable database 6, the privilege escalation risk scanning and analyzing agent 11 may compare found executables with information of the elevated privilege executable database 6 to determine whether that executable belongs to the elevated privilege executables. If the first identification phase reveals that the executable is known to be run with the elevated privilege, that executable may for example be included in a first list.

According to example embodiments of the disclosure, the privilege escalation risk scanning and analyzing agent 11 may further gather 404, e.g. from the behavioral data source, at least one of the following: every executable (e.g. executable file) executed by an elevated privileged executable, every dynamic link library loaded by an elevated privileged executable and every registry key value read and executed by an elevated privileged executable. In other words, the first identification phase may further comprise that the privilege escalation risk scanning and analyzing agent 11 further gathers executables executed by each elevated executable identified in the first identification phase, dynamic link library loaded by each elevated executable identified in the first identification phase, and/or registry key values read and executed by each elevated executable identified in the first identification phase. The gathered data may further be included in the first list.

After the first identification phase, the privilege escalation risk scanning and analyzing agent 11 performs 404 a second identification phase by checking file access permissions to the executables identified in the first identification phase for identifying executables which are writable and/or modifiable by a privilege level lower than the elevated privilege. In other words, in the second identification phase the privilege escalation risk scanning and analyzing agent 11 identifies from among the executables identified in the first identification phase executables which are writable and/or modifiable by a privilege level lower than the elevated privilege by checking file access permissions to the executables identified in the first identification phase.

If any executables are identified in the second identification phase, the privilege escalation risk scanning and analyzing agent 11 generates 405 an alert for the executables identified in the second identification phase. For example, if the executables identified in the second identification phase are included in the second list, the privilege escalation risk scanning and analyzing agent 11 may generate the alert for the executables which have been included in the second list. The alert may for example be sent to an exposure management service and/or to a vulnerability management service to provide an indication of potential privilege escalation risk(s). The alert may be, for example, a flag (e.g. one bit) which is set to a value “true” (e.g. by setting the value of the bit to 1) indicative of a detected potential privilege escalation risk. The privilege escalation risk scanning and analyzing agent 11 may for example generate a report or other information of the executables identified in the second identification phase and provide an indication of the potential privilege escalation risk(s).

According to example embodiments of the disclosure, the detected privilege escalation risk may be used, e.g. by the exposure management service and/or the vulnerability management service, for determining at least one of the following: a risk score for the host 1, a risk score for an attack path on which the host 1 is, a risk score for the organization relating to the host 1.

According to example embodiments of the disclosure, the privilege escalation risk analyzing agent 5 (when the detection is performed by the server 2) and/or the privilege escalation risk scanning and analyzing agent 11 (when the detection is performed by the host 1) may further check in the second identification phase file access permissions to the executables identified in the first identification phase for identifying executables (e.g. executable files) which are writable and/or modifiable by a privilege level lower than the elevated privilege and known to be executed by the executables identified in the first identification phase. In other words, in addition to identifying executables itself being writable and/or modifiable by the privilege lower than the elevated privilege, the second identification phase may further comprise identifying other executables which are writable and/or modifiable by the privilege level lower than the elevated privilege and known to be executed by the executables identified in the first identification phase. The alert may also be generated for these other executables identified in the second identification phase.

According to example embodiments of the disclosure, if an executable location (i.e. a location of an executable) does not exist on a computer file system in the host 1, the privilege escalation risk analyzing agent 5 (when the detection is performed by the server 2) and/or the privilege escalation risk scanning and analyzing agent 11 (when the detection is performed by the host 1) may further determine whether a required directory structure is creatable to the computer file system with the privilege level lower than the elevated privilege and an executable could be executed with the elevated privilege from that directory structure. The alert may also be generated for these not yet existing but creatable direction structures and executables that could be executed with the elevated privilege from these directory structures. This enables that the privilege escalation risk may be detected also in cases, where the executable location does not even exist yet on the computer file system in the host 1. In other words, it enables to determine whether a threat actor (e.g. an attacker) could be able to create with the privilege level lower than the elevated privilege the required directory structure and executable that the elevated privilege executable would execute, even if the location does not exist on the computer file system in the host 1. This improves spotting and preventing host specific vulnerabilities. According to a non-limiting example, the host 1 may have a history of executing an elevated privilege executable Bios flasher.exe that could execute an executable (e.g. % TEMP %\bios_updatelextarct.exe) in an executable location that does not exist on the computer file system in the host 1. The privilege escalation risk analyzing agent 5 and/or the privilege escalation risk scanning and analyzing agent 11 may determine whether the required directory structure % TEMP %\bios_update directory is creatable to the computer file system with the privilege level lower than the elevated privilege and the executable % TEMP %\bios_update\extract.exe could be executed with the elevated privilege executable Bios flasher.exe from the directory structure % TEMP %\bios_update directory.

According to example embodiments of the disclosure, privilege escalation risk detection at the host 1 and/or by the server 2 can be realized using a malware analysis environment, such as a virtual machine or emulator environment, arranged at the host 1 and/or at the server 2. In other words, the method may be performed by a virtual machine or software emulator running on the host 1 and/or on the server 2. For example, a privilege escalation risk detection agent, such as an anti-virus software can be installed/arranged at the host 1 to be used for privilege escalation risk detection.

Based on the possibly detected privilege escalation risks malicious behavior of the software application may also cause the host 1 disabling such executable which is writable and/or modifiable by a privilege level lower than the elevated privilege and possibly also known to be executed by the executables known to be run with an elevated privilege (i.e. executed by executables identified in the first identification phase) at the virtual machine or the software emulator, the local machine is notified about the malicious behavior and the virtual machine or the software emulator session is ended.

In accordance with an embodiment the host 1, based on the notification from the software application, stops execution of such executable if it is already running or prevents starting the execution of such executable.

In accordance with an embodiment, the host 1, based on the notification from the software application, prevents writing to such memory area where such writable and/or modifiable executable are located.

In accordance with an embodiment, based on receiving the notification about malicious behavior of the software application, the software application at the local machine is terminated and changes made by the application or to the at least one file or system configuration value are reverted based on the backed-up version of the at least one file and/or system configuration value.

In one embodiment of the disclosure the virtual machine or software application or an emulator may be running on the local machine (e.g. the host 1) and/or on the server 2, such as a LAN-server.

As presented in FIG. 5, an arrangement 510 or at least part of the arrangement, e.g. an endpoint and/or a server, according to example embodiments of the present disclosure may comprise at least one processor 511 and at least one memory 512 (and possibly also at least one interface 513), which may be operationally connected or coupled, for example by a bus 514 or the like, respectively.

The processor 511 of the arrangement 510 is configured to read and execute computer program code stored in the memory 512. The processor may be represented by a CPU (Central Processing Unit), a MPU (Micro Processor Unit), etc., or a combination thereof. The memory 512 of the arrangement 510 is configured to store computer program code, such as respective programs, computer/processor-executable instructions, macros or applets, etc. or parts of them. Such computer program code, when executed by the processor 511, enables the arrangement 510 to operate in accordance with example embodiments of the present disclosure. The memory 512 may be represented by a RAM (Random Access Memory), a ROM (Read Only Memory), a hard disk, a secondary storage device, etc., or a combination of two or more of these. The interface 513 of the arrangement 510 is configured to interface with another arrangement and/or the user of the arrangement 510. That is, the interface 513 may represent a communication interface (including e.g. a modem, an antenna, a transmitter, a receiver, a transceiver, or the like) and/or a user interface (such as a display, touch screen, keyboard, mouse, signal light, loudspeaker, or the like).

The arrangement 510 may, for example, represent a (part of a) first node, such as local entity or host 1 in FIG. 1, or may represent a (part of a) second node, such as remote entity or server 2 in FIG. 1. The arrangement 510 may be configured to perform a procedure and/or exhibit a functionality as described in any one of FIGS. 3 to 4.

The data collected with the solution of the disclosure may be stored in a database or similar model for information storage for further use.

In an embodiment, further actions may be taken to secure the computer or the computer network when a malicious executable, application or activity has been detected. Also actions by changing the settings of the computers or other network nodes can be done. Changing the settings may include, for example, one or more nodes (which may be computers or other devices) being prevented from being switched off in order to preserve information in RAM, a firewall may be switched on at one or more nodes to cut off the attacker immediately, network connectivity of one or more of the network nodes may be slowed down or blocked, suspicious executables may be removed or placed into quarantine, logs may be collected from network nodes, sets of command may be executed on network nodes, users of the one or more nodes may be warned that a risk or anomaly has been detected and that their workstation is under investigation, and/or a system update or software patch may be sent from the security backend to the nodes. In one embodiment of the disclosure one or more of these actions may be initiated automatically.

Although the disclosure has been described in terms of various embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein. Lists and groups of examples provided in the description given above are not exhaustive unless otherwise explicitly stated.

1. A computer-implemented method of privilege escalation risk detection in a host or a network, wherein the method comprises:
examining which executables are running in the host;
searching behavioral information of the executables running in the host;
performing a first identification phase for identifying executables running in the host which the behavioral information indicates are known to be run with an elevated privilege;
performing a second identification phase by checking file access permissions to the executables identified in the first identification phase for identifying executables which are writable or modifiable by a privilege level lower than the elevated privilege; and
generating an alert for the executables identified in the second identification phase.

2. The method according to claim 1, wherein the behavioral data source comprises at least one of: process execution telemetry, process EDR source, process MDR source, and a process monitor.

3. The method according to claim 1, wherein the alert is sent to an exposure management service or a vulnerability management service.

4. The method according to claim 1, wherein the detected privilege escalation risk is used for determining at least one of: a risk score for the host, a risk score for an attack path comprising the host, and a risk score for the organization relating to the host.

5. The method according to claim 1, further comprising:
gathering in the first identification phase at least one of the following: every executable executed by an elevated privileged executable, every dynamic link library loaded by an elevated privileged executable, and every registry key value read and executed by an elevated privileged executable.

6. The method according to claim 1, wherein the behavioral information for the executables comprises at least one of: process execution information, read access rights relating to the executables, and write access rights relating to the executables.

7. The method according to claim 1, wherein the method is performed by the host.

8. The method according to claim 1, wherein the method is performed by a virtual machine or software emulator running on a server.

9. The method according to claim 1, wherein the second identification phase further comprises:
checking file access permissions to the executables identified in the first identification phase for identifying executable which are writable or modifiable by a privilege level lower than the elevated privilege and known to be executed by the executables identified in the first identification phase.

10. The method according to claim 9, further comprising determining whether a required directory structure is creatable to a computer file system in the host and an executable could be executed with an elevated privilege from that directory structure if the executable location does not exist on the computer file system in the host.

11. A system for privilege escalation risk detection in a host or a network, wherein the arrangement comprises at least one computing device having at least one hardware processor that, when executing program instructions stored in memory, is directed to perform a method comprising:
examining which executables are running in a host;
searching behavioral information of the executables running in the host;
performing a first identification phase for identifying executables running in the host which the behavioral information indicates are known to be run with an elevated privilege;
performing a second identification phase by checking file access permissions to the executables identified in the first identification phase for identifying executables which are writable or modifiable by a privilege level lower than the elevated privilege; and
generating an alert for the executables identified in the second identification phase.

12. The system according to claim 11, wherein the behavioral data source comprises at least one of: process execution telemetry, process EDR source, process MDR source, and a process monitor.

13. The system according to claim 11, wherein the alert is sent to an exposure management service or a vulnerability management service.

14. The system according to claim 11, wherein the detected privilege escalation risk is used for determining at least one of: a risk score for the host, a risk score for an attack path comprising the host, and a risk score for the organization relating to the host.

15. The system according to claim 11, wherein the method further comprises:
gathering, in the first identification phase, at least one of: every executable executed by an elevated privileged executable, every dynamic link library loaded by an elevated privileged executable, and every registry key value read and executed by an elevated privileged executable.

16. The system according to claim 11, wherein the behavioral information for the executables comprises at least one of: process execution information, read access rights relating to the executables, and write access rights relating to the executables.

17. The system according to claim 11, wherein the method is performed by the host.

18. The system according to claim 11, wherein the method is performed by a virtual machine or software emulator running on a server.

19. The system according to claim 11, wherein the second identification phase further comprises:
checking file access permissions to the executables identified in the first identification phase for identifying executable which are writable or modifiable by a privilege level lower than the elevated privilege and known to be executed by the executables identified in the first identification phase.

20. A non-transitory computer-readable medium embodying program instructions executable by at least one hardware processor that, when executed, direct the at least one hardware processor to:
examine which executables are running in a host;
search behavioral information of the executables running in the host;
perform a first identification phase for identifying executables running in the host which the behavioral information indicates are known to be run with an elevated privilege;
perform a second identification phase by checking file access permissions to the executables identified in the first identification phase for identifying executables which are writable or modifiable by a privilege level lower than the elevated privilege; and
generate an alert for the executables identified in the second identification phase.
